(19) United States
(12) Patent Application Publication
(10) Pub. No.: US 2006/0050068 A1
(43) Pub. Date: Mar. 9, 2006

(54) Apparatus for producing three-dimensional static or dynamic images

(75) Inventors: Denis J. Stemmle, Stratford, CT (US); Douglas B. Quine, Bethel, CT (US)

Correspondence Address: Pitney Bowes Inc.;Intellectual Property & Technology Law Department, 35 Waterview Drive, P.O. Box 3000, Shelton, CT, 06484, US

(73) Assignee: Pitney Bowes Incorporated, Stamford, CT (US)

(21) Appl. No.: 10/925,486

(22) Filed: Aug. 25, 2004

(51) Int. Cl. G06T 15/00

(52) U.S. Cl. 345/419

(57) ABSTRACT

A display apparatus creates a modifiable three-dimensional image. The apparatus includes a plurality of non-planar pixel units arranged substantially on a plane. Each of the non-planar pixel units has a visual impact that is a function of direction. An electronic device is provided for modifying said functions to change the three-dimensional image.

### TECHNICAL FIELD

The present invention relates to display screens, and more particularly to display screens that provide three-dimensional images.

### BACKGROUND OF THE INVENTION

Three-dimensional (3D) images in the prior art have been either static or dynamic. While it has been possible to create static 3D images without requiring special viewing glasses heretofore, there has not been a way to create dynamic 3D images this way. In one example of prior art, faceted substrates are used in which the left and right eyes of the viewer see different images created on the different facets of the picture. ViewMasters employed a technique of using two completely different pictures each viewed separately by the left and right eye through two lenses, one dedicated to each eye.

Another method of creating static 3D images has been to superimpose dual images on a flat surface, each slightly different from each other. These separate images are either transmitted or blocked by special tinted or polarized lenses. This method requires the viewer to wear special tinted or polarized glasses to view the images and see them as 3D. This same technique has been adapted to create 3D images in movies. To date the vast majority of either static or dynamic 3D images require the viewer to wear special glasses or be assisted in other ways by separate optical devices, one dedicated to each eye.

On the other hand, unrelated to 3D prior art, a technique for creating two-dimensional (2D) images has been developed at the Massachusetts Institute of Technology. See Comiskey et al. (U.S. Pat. No. 6,738,050) which is incorporated herein by reference. As of yet, this technology, which is sometimes called “electronic graphics” (and is hereinafter called “electronic graphics”) has not been extended to 3D imaging.

### SUMMARY OF THE INVENTION

This invention enables the viewer to see an image on a plane as 3D without requiring assistance from any optical device or other device proximate to the user. The idea of the present invention utilizes, for example, the non-planar nature of the pixels currently used in electronic graphics technology. Such non-planar pixels may be spherical, cubical, or may employ other geometric shapes including tetrahedrons and flat pixels in conjunction with other respective elements.

According to one aspect of the present invention, a display apparatus creates a modifiable 3D image. The apparatus includes a plurality of non-planar pixel units arranged substantially on a plane, and each of the non-planar pixel units has a visual impact that is a function of direction. For example, the pixel unit has a different gray value depending upon the vantage point. The apparatus also includes an electronic device for modifying those functions to change the 3D image.

According to another aspect of the present invention, each of the plurality of non-planar pixel units comprises a liquid crystal display element separated from a viewer by a facet of a faceted deflector (the facet being non-planar in the sense that it is in a different plane from the LCD element). The facet will deflect light to the right eye or to the left eye, and typically each facet will be adjacent to facets that deflect to the other eye.

According to another aspect of the present invention, each of the plurality of non-planar pixel units has at least one optical barrier for preventing at least one eye from seeing at least part of the pixel unit. So for example, the pixel unit may include an LCD element or an electronic graphics element, and the optical barrier would allow that element to be seen by one eye but not by the other eye.

According to a further aspect of the present invention, at least two strobe lights are provided for backlighting each of the pixel units with strobed light pointing in at least two respective directions. These strobes can enhance the 3D effect already created by using the non-planar pixel units (the strobes could be used with planar pixels as well).

According to yet a further special case of the present invention, the display apparatus creates a 3D image utilizing electronic graphics. The non-planar pixel units are translucent capsules, arranged on a plane, each capsule including a first group of charged chips, and also a second group of oppositely charged chips having a different appearance from the first group. Two electrodes position the first and second groups of chips within each capsule. For some combinations of chip positions, a visible ratio of the charged chips to the oppositely charged chips in each capsule is a function of position from which the display is viewed, and this function is controlled by the positioning performed by the electrodes. The image formed by a number of capsules, each functioning as an individual pixel, can be seen by the viewer as a 3D image.

As mentioned, the 3D effect can be enhanced by backlighting the display with strobes and, respectively, projecting different images into each eye of a user, those two different images being formed either by 2D electronic graphics or, alternatively by the 3D electronic graphics of the present invention. It should be noted that it is also possible to take advantage of “flicker fusion” wherein human vision merges brief images into the impression of a stable image (the basis of movies). For example, if we make the electronic graphics image for the right eye but use all black pixels for the left eye with a bright backlight, then rapidly switch and make a black image for the right eye, the brain will perceive a stable left image and a stable right image.

The present 3D invention has potential application anywhere the electronic graphics technology can be used, such as display panels, simulated paper applications, posters, texts and other images where electronic graphics displays can be applied. The electronic graphics technology can provide either semi-permanent images or dynamic images when supported by appropriate software. The present 3D concept can also be applied to viewing screens used in computers, televisions, store displays and control panels for equipment, among other things.

Electronic graphics consist of transparent spheres containing positively charged white pigment chips and negatively charged black pigment chips. An electronic graphics sphere of the present invention can be made to appear all black, all white, half black on the left, or half black on the right. The spherical nature of the pixels when viewed from the appropriate angle and distance, results in selectably different gray values for a group of pixels appearing to the left and right eyes. These separate levels of gray images will be integrated by the viewer's brain into a single image which will appear as a 3D image. The effect is strongest with dark pixels being viewed with one eye and light pixels being viewed with the other eye. The images can be static or dynamic, subject only to the limitations of the electronic graphics technology. No special glasses or any other devices need to be worn by the user (e.g., placed in proximity to the user).

The 3D resolution is enhanced by doubling the bottom electrode grid mesh. Each sphere then experiences two charges which separate the images visible through the top to half white and half black for each sphere. Thus, the images created are one of the following four possibilities: A—black pixel; B—white pixel; C—black left/white right; or D—black right/white left.

A significant opportunity exists to create 3D images using the electronic graphics technology based on the principle that the left eye of the viewer will see a different image of each half white/half black sphere than the viewer's right eye will see. Of course, the principle of 3D imagery is that the left eye sees a slightly different picture than the right eye sees. When the viewer's brain integrates the two images into one, a 3D image with a realistic depth dimension is created in the mind. The spherical nature of the pixels using the electronic graphics technology can be exploited to create 3D images without using special glasses or any other type of aid to create the 3D effect. The present invention creates images by using the electronic graphics technology, combined with dithering methods of grouping smaller pixels into larger pixels to create a range of gray scale pixels, and organizing the information so that the left eye and right eye see two different gray scale images while looking at the same group of pixels in a dither pattern.

One of the innovations of the present invention is to position the spheres so that the line between black and white is vertical for 3D mode but horizontal for 2D mode; thus, opposite charges will cause the black portion to be left or right versus up or down. Because the left eye views any sphere at a different angle in the right to left axis than the right eye, the left eye will see a lighter or darker image than the right eye when the black-to-white boundary is vertical. If the black to white boundary is horizontal, the two eyes will see the same mixture of black and white (the same gray scale). Therefore, vertical black/white boundaries may be used for 3D effect while horizontal black/white boundaries will equal gray scale values to both eyes—allowing a full range of gray values from black to white to be displayed equally to both eyes. Spheres can be grouped into dither patterns to create a full range of gray scales that will be different for left or right eyes. Each sphere position remains binary—black left or black right. This invention enables the viewer to see a flat image as 3D without requiring assistance from any optical device or other device.

### BRIEF DESCRIPTION OF THE DRAWINGS

FIG. 1A is a side view showing a transparent or translucent capsule with pigmented (e.g., black) negatively charged chips at the top and other positively charged chips at the bottom.

FIG. 1B shows a transparent or translucent capsule with pigmented charged chips at the bottom and other chips at the top.

FIG. 1C shows a transparent or translucent capsule with pigmented charged chips at the top left and bottom right.

FIG. 1D shows a transparent or translucent capsule with pigmented charged chips at the top right and bottom left.

FIG. 2A shows a top view of the capsule shown in FIG. 1A as viewed by a human.

FIG. 2B shows a top view of capsule shown in FIG. 1B as viewed by a human.

FIG. 2C shows a top view of capsule shown in FIG. 1C as viewed by a human.

FIG. 2D shows a top view of capsule shown in FIG. 1D as viewed by a human.

FIG. 3A shows a viewer observing a capsule having black and white hemispheres.

FIG. 3B shows the view from a viewer's left eye of the capsule shown in FIG. 3A.

FIG. 3C shows the view from a viewer's right eye of the capsule shown in FIG. 3A.

FIG. 4 shows a viewer observing the capsule shown in FIG. 3A including dimensions.

FIG. 5 shows a view from the right eye of the scenario in FIG. 4, including dimensions.

FIG. 6 shows an offset viewer observing an electronic graphics capsule.

FIG. 7A shows an incremental white crescent area as seen by the left eye, including dimensions.

FIG. 7B shows an incremental white crescent area as seen by the right eye, including dimensions.

FIGS. 8A-J show pixels formed by dithering a 3×3 matrix of elements.

FIGS. 9A-L show further pixels formed by dithering a 3×3 matrix of elements.

FIG. 10A shows a box and reference line as viewed from the left eye, with a line of pixels that intersects the view.

FIG. 10B shows a box and reference line as viewed from the right eye, with a line of pixels that intersects the view.

FIG. 10C shows the line of pixels corresponding to FIG. 10A.

FIG. 10D shows the line of pixels corresponding to FIG. 10B.

FIG. 11 shows an LCD display backlit by two strobes, with optical barriers between the pixels.

FIG. 12 shows an LCD display backlit by two pairs of strobes.

FIGS. 13A-C shows a situation as in FIGS. 3A-C, except using tetrahedrons instead of spheres.

FIGS. 14A-C shows a situation as in FIGS. 3A-C, except using (instead of a sphere) two planar facets mounted at angles to the plane of the image and at an angle to each other.

FIG. 15 shows detail of the planar facets of FIG. 14A as viewed by one eye.

FIG. 16 shows a faceted deflector design using a nearby point of light.

FIG. 17 shows a faceted deflector design using a distant light source.

FIGS. 18A-E show the upper left-hand corner and reference line of the boxes in FIGS. 10A-B.

FIG. 19A shows a right eye viewing an image as seen in a plurality of facets mounted at angles to the plane of the image.

FIG. 19B shows the images seen in the scenario of FIG. 19A.

FIGS. 20A-B correspond to FIGS. 19A-B, except for the left eye instead of the right eye.

FIGS. 21A-B superimpose the results of FIGS. 19 and 20.

FIG. 22 shows the optical barriers of FIGS. 11 and 12 without strobes.

FIG. 23 shows the apparatus of FIG. 22 but excluding interactions with the left eye.

FIG. 24 shows the apparatus of FIG. 22 but excluding interactions with the right eye.

FIG. 25 is the same as FIG. 23 except viewed from a greater distance.

### BEST MODE FOR CARRYING OUT THE INVENTION

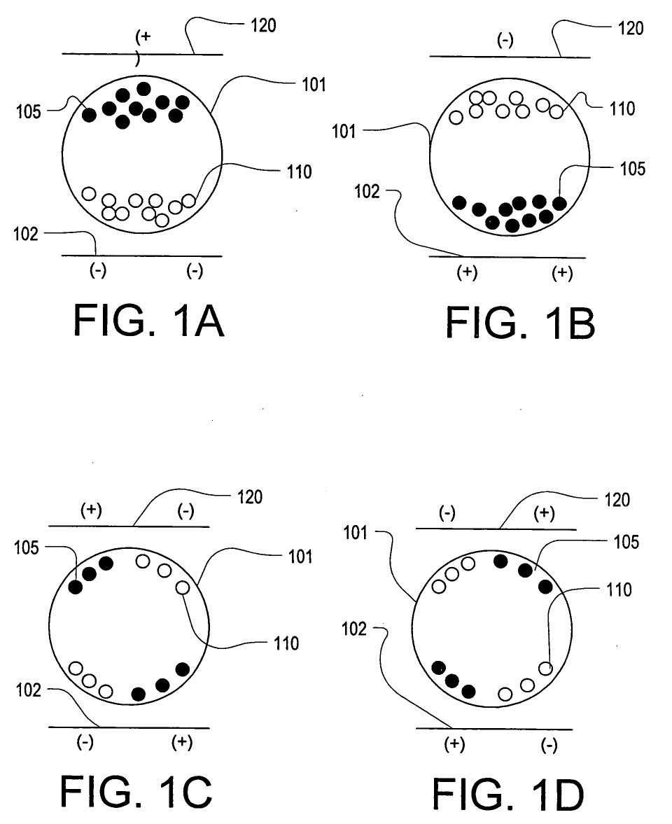

FIGS. 1A thru 1D illustrate the transparent sphere 101 located above a double electrode grid mesh 102 that applies to the sphere two charges which may be the same or different. In FIG. 1A, the charges are both negative, causing the negatively charged black chips 105 to rise and the positively charged white chips 110 to fall. Likewise, FIG. 1B shows the charges both being positive. In FIGS. 1C and 1D, the grid mesh 102 is providing both a positive and a negative charge to the bottom of the sphere 101, and charges may also be applied to a top electrode 120 (e.g., in FIGS. 1C and 1D both positive and negative charges are applied to the top electrode 120). Of course, it is to be understood that an alternative embodiment having black and white chips that are respectively charged positively and negatively (instead of negatively and positively) would be just as acceptable.

A top layer 120 may be used that is transparent or translucent so that the spheres can be seen from above. This top layer 120 may include, for example, one or more electrodes that are largely invisible (e.g., transparent or translucent) so that there would be electrodes on top as well as at the bottom. Especially in FIGS. 1C and 1D, an embodiment having top electrodes would be useful to enhance resolution and ensure proper distribution of the chips. However, it should be understood that top electrodes are not absolutely necessary, and a similar result can be achieved using, for example, side electrodes.

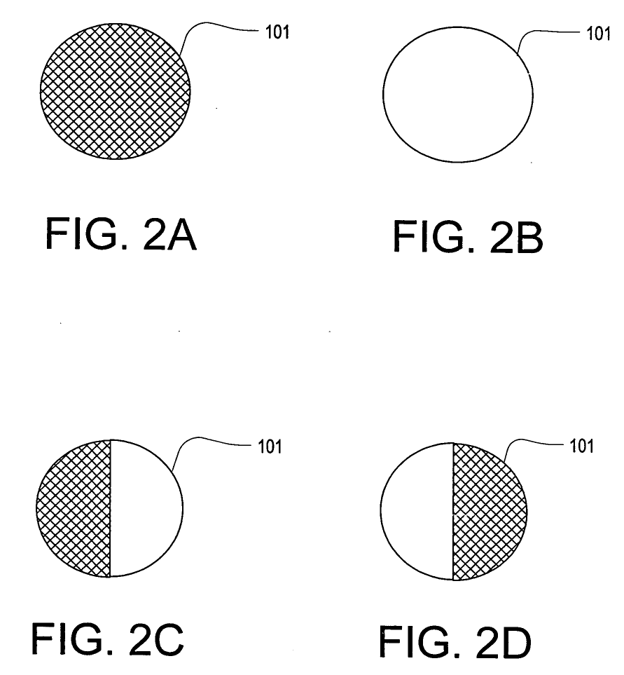

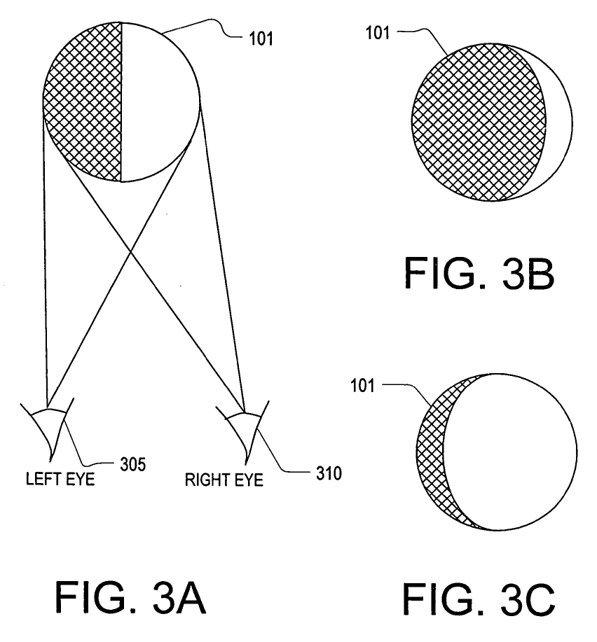

FIGS. 2A thru 2D provide a top view of FIGS. 1A thru 1D, respectively. It will be appreciated that the size of the chips in the spheres and the size of the spheres themselves will be quite small so that multiple spheres will be easily merged by the human eye to form a coherent image when viewed from a comfortable viewing distance. Concentrating now on FIG. 1C and FIG. 2C, these show the sphere such that, when viewed from directly above, the sphere appears black on the left and white on the right to a human viewer. FIG. 3A illustrates this viewing process, including a left eye 305 and a right eye 310. The view from the left eye is shown in FIG. 3B, and the view from the right eye is shown in FIG. 3C. Thus, the gray level for the integrated image of the sphere as viewed by the left eye will be darker than the right eye, and this phenomenon is used by the present invention to create a 3D effect.

The gray level that the left eye sees on any one sphere of electronic graphics (with half the sphere black and half white) is different from the gray level that the right eye sees due to the slightly different viewing angle of the spherical surface. The degree of difference in the gray value between the left and right eyes depends on the distance between the image and the eyes. If we assume a reading distance of about 12 inches, and a relatively large distance between the left and right eye in a human of 4 inches, then the differences in gray value between the left and right eye can be estimated.

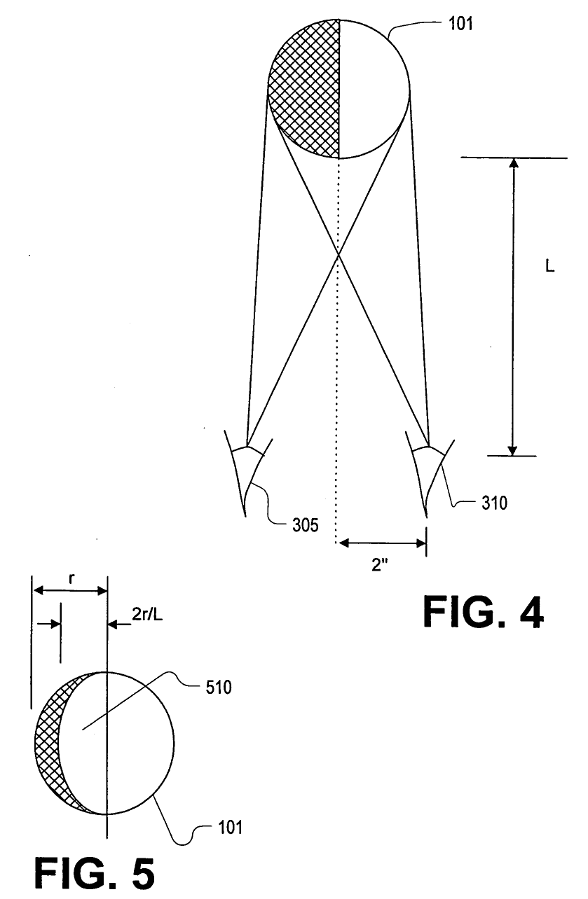

Referring to FIG. 4, the sphere will appear to each eye as if its axis is rotated. Viewed from the right eye 310, the line separating the white and black segments of the sphere will appear as shown in FIG. 5. The visible ratio of the black area to the white area will cause a lighter shade for the right eye 310 but a darker shade for the left eye 305. If L=14″, then the gray value for the left eye is about 0.553; and for the right eye, the gray value is about 0.447, on a scale where black=1 and white=0.

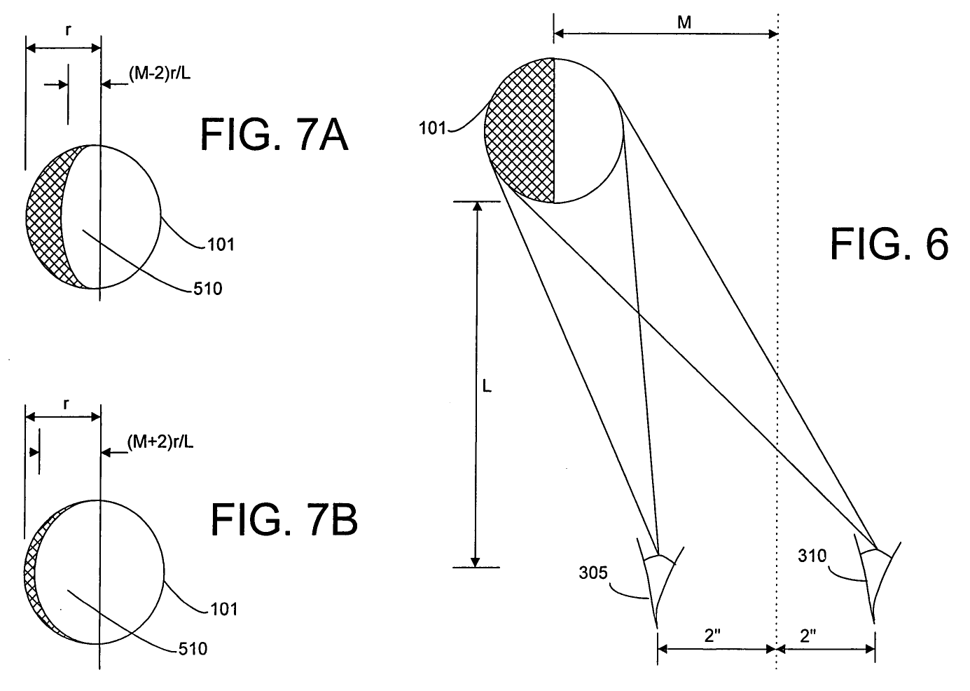

Note that not all pixels will be viewed straight on as shown in FIG. 4. Instead, when normally reading a standard size book or page of information, some of the spheres in the matrix will be viewed off axis, as shown in FIG. 6. This situation can be represented, for example, by tilting the panel containing the electronic graphics spherical pixels 101 at an angle having a tangent value equal to M/L. In general, the effect of this geometry is that both eyes will see more white than black, but the right eye will see a larger white crescent (in FIG. 7B) than the left eye (see FIG. 7A).

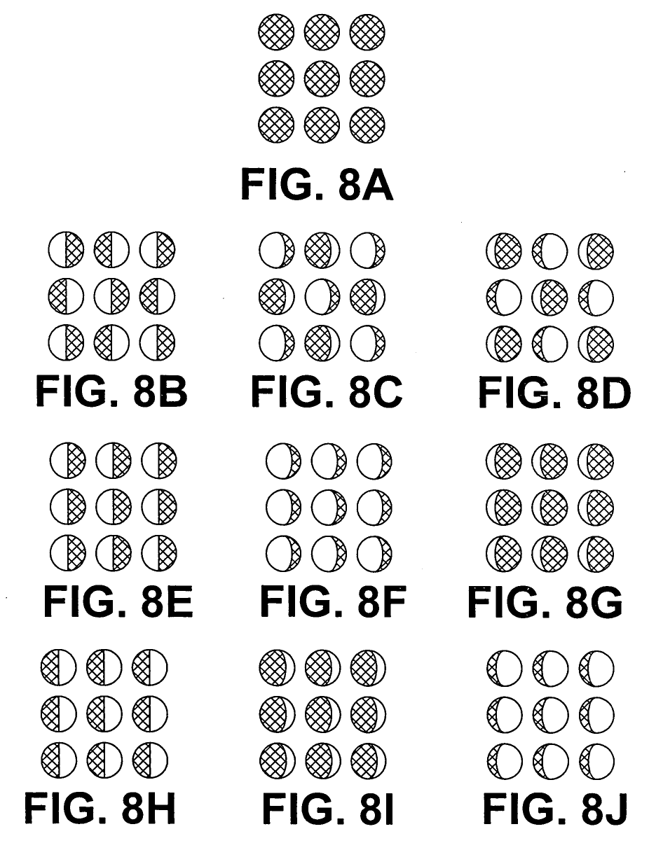

The differences in gray values can be combined into larger pixels in dithering (i.e., “clumped”) patterns to create a range of gray (using black/white spheres) or color (using spheres with primary colors) values viewed differently by the left and right eyes. As an example, consider a system that integrates nine small (spherical) pixels 101 into a single larger (dithered) pixel, as in FIGS. 8A-J. For the sake of simplicity to illustrate the invention, we will make two assumptions. First, suppose that the larger dithered pixel will be composed of a 3×3 matrix of nine smaller (spherical) pixels. It will be appreciated that numerous other options could be considered, such as 2×2 matrix, 4×4 matrix or even rectangular matrices such as 2×4, et cetera. Second, for the sake of illustration, assume that the images will be viewed from a distance of L=14″, and therefore, the gray values of a single spherical pixel element 101 that is half black and half white will be seen with the different gray values of 0.447 or 0.553 discussed above, depending upon which side is black and which eye is viewing it. The difference between left and right eye gray level is 0.106.

To illustrate the dithering concept, consider now a gray scale whose overall level of “grayness” is established by totaling the number of black images within any one large (dithered) pixel. The values will vary from a value of zero if each of the nine spherical pixels is white (as in FIG. 2B) to a value of nine if each of the nine spherical pixels is black (as in FIG. 2A). By adding values of pixels that are 0.447 gray or 553 gray to some of the nine spherical pixels in the dithered matrix, a wider range of gray levels can be created.

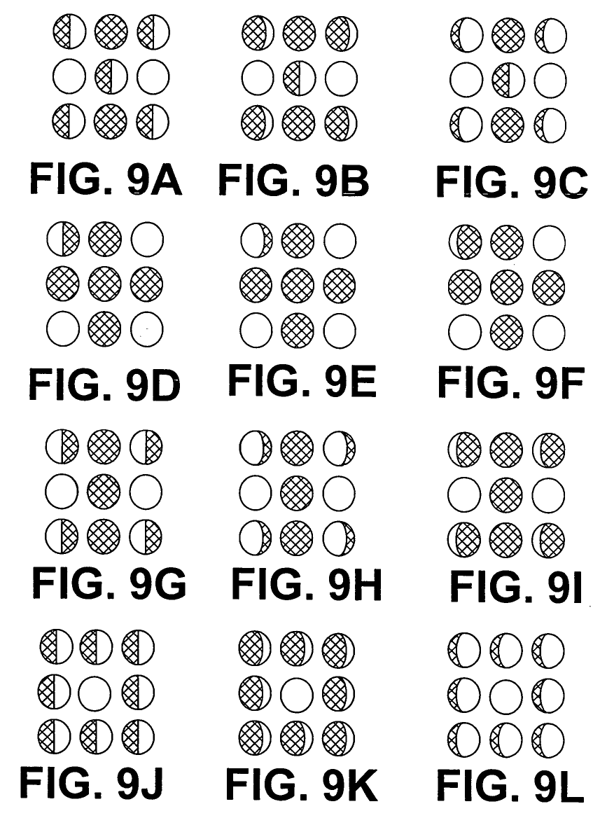

FIG. 8A shows nine elements that are entirely black, so the gray value will be 1.0 as viewed straight on or as viewed from either eye. In contrast, FIGS. 8B, 8E, and 8H show three straight-on views that have gray values of 0.5. The left-eye views of FIGS. 8B, 8E, and 8H are shown, respectively, in FIGS. 8C, 8F, and 8I, and they have respective gray values of 0.494, 0.447, and 0.553 even though the respective straight-on gray values are all the same. The right-eye views are shown in FIGS. 8D, 8G, and 8J, respectively, having gray values of 0.506, 0.553, and 0.447. Further dithering examples are shown in FIGS. 9A-L. The straight-on views are in the first column of FIGs; the left-eye views are in the second column of FIGS; and the right-eye views are in the third column.

Dithering is an important concept that has the potential to substantially expand the range of gray scale values resulting from the 3D effect of the present invention. The important principle here is that the left and right eyes can be made to see different shades of gray to create the 3D effect.

For a perfect 3D imaging, a technology should allow the left eye to see a totally black pixel while the right eye sees a totally white pixel. However, for pictorial images that are built from a wide range of gray pixels of various gray values, some 3D effect can be created using the method described herein. Further techniques for increasing the effect described herein include changing the shape of the individual electronic graphics pixels from true spherical shape to an oblong sphere in order to amplify the differences between what is seen by the left and right eyes.

The disclosure has thus far described a method for creating a 3D effect using reflected light with the existing electronic graphics technology that has previously only been used for 2D applications. This method will create effective 3D images in some applications, such as gray scale images, while for line art an effective 3D image need not be created using this technique as described above. This fact can be beneficial in that this embodiment of the method enables 3D images for gray scale applications while simultaneously insuring only 2D images will be created for text, which is normally black letters on a white background, or vice versa.

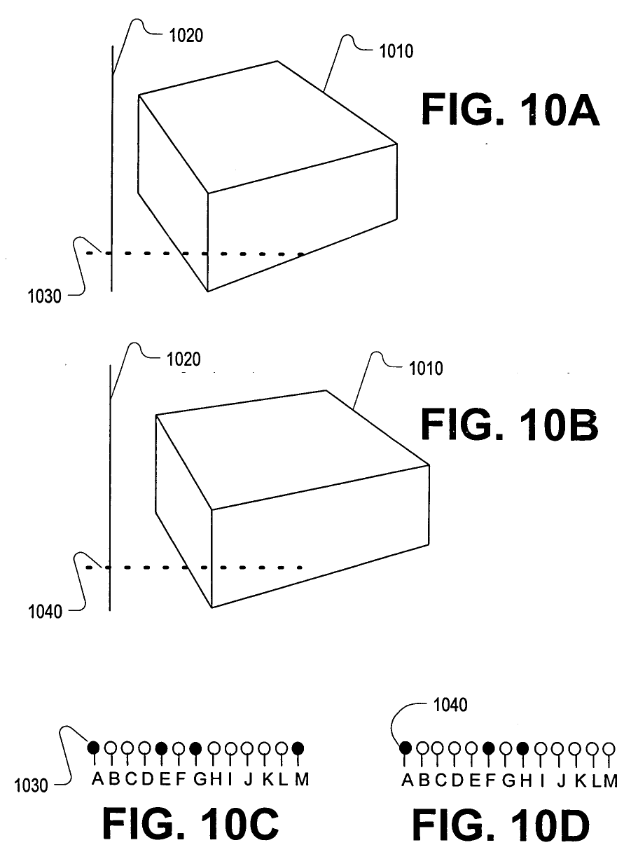

For creating 3D images with line art, which is largely black and white images with no gray shades in between, a variant of the proposal will be used beneficially to create 3D images. Consider a line art image of a simple box 1010 shown in FIG. 10A. In order for that box to stand out from the background in a typical 3D image, the left and right eye images would be substantially different, as shown in FIG. 10B of the right eye image. Notice that the left rear portion of the box appears to be much closer to the reference line 1020 in the image seen by the left eye than in the right eye. The shape of the box is also slightly different. Thus, if a line of pixels in an image taken at the lines 1030 and 1040 were to be examined, the images for that small segment would be as shown in FIGS. 10C and 10D, for the left and right eyes, respectively.

For the left eye, pixel A represents an element that images a segment of the reference line 1020, pixel E represents an element of the left lower horizontal line of the box, pixel G represents an element of the left front vertical line of the box, and pixel M represents a segment of the lower right horizontal line of the box. For the right eye, pixel A remains the same as for the left eye since the reference line is viewed in the same position by the left and right eyes. But, pixel F instead of pixel E is the image of the lower left horizontal element of the box, and pixel H rather than pixel G represents an element of the left front vertical line of the box, in the view of the right eye. Finally, pixel M is black for the left eye and white for the right eye image.

The unmodified electronic graphics technology as currently practiced contains a number of spheres, each containing black and white opaque pigments, each with a different charge, arrayed over an addressable grid such that either block or white can be moved to the top (viewable) portion of each sphere depending on the charge applied to the grid. Furthermore, the present technology enables the spheres to appear half black and half white by applying a combination of positive and negative charges to the grid to move the black pigmented elements to either the left or right sides of the spheres, depending on the charge combination. Both opaque pigments and translucent pigments can be used in an array of the spheres 101, each sphere being modifiable to selectively transmit or prevent transmission of light passing through a translucent addressable grid positioned behind the spheres. Alternatively, other display technologies such as liquid crystal displays are useful in the present context instead of the electronic graphics technology.

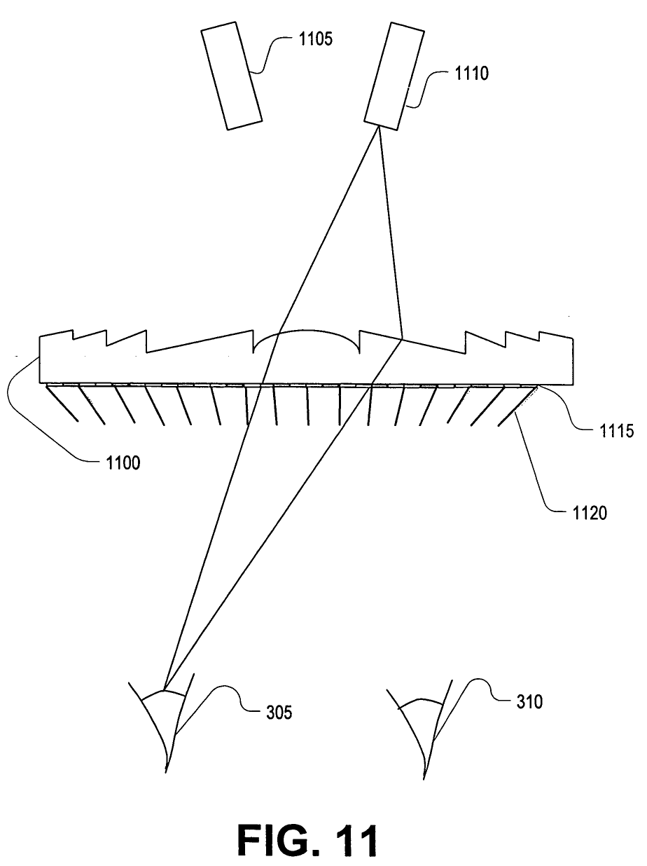

Combined with the modified or unmodified electronic graphics display panel or alternative display technologies are, for example, two strobing light sources. As seen in FIG. 11, an array of LCD pixels 1115 is separated from the user's eyes (305 and 310) by optical barriers 1120. A fresnel lens 1100 serves to direct the light emanating from the strobes. The strobes 1105 and 1110 backlight the arrangement. The optical arrangement of the individual strobes and lens is such that light from one strobe is directed to the left eye and the light from the other strobe is directed to the right eye of the viewer. The light strobes are synchronized with the images on the panel 1115 so that one image created on the display panel created with electronic graphics or an alternate technology is seen primarily by the left eye when the strobe associated with the left eye is flashed, and a different image created on the display panel created with electronic graphics or an alternate technology is seen primarily by the right eye when the strobe associated with the right eye is flashed. The viewer's brain integrates these two images into a single image that appears to the viewer as a 3D image. Both the strobe flashes and the images created for the left and right eyes can be made to change at high frequency to create the appearance of 3D images in motion. The 3D images can be static or dynamic, subject only to the limitations of the electronic graphics, LCD, or alternate display technology. The clarity of the 3D images will depend on the scatter as the light is transmitted through the pixels 1115. Less scatter will create a better 3D effect. With the optical barriers 1120 in place in FIG. 11, both the image for the left eye and the image for the right eye can be displayed on the LCD array simultaneously, and both strobes flashed simultaneously. This is an alternative embodiment that is enabled by the presence of the optical barriers.

The present enhancement requires only a display technology which can selectively change any pixel from opaque to translucent and vice versa. For this reason, the display used in this variant might be electronic graphics in which the black pigment elements remain the same but translucent pigments are substituted for the white opaque pigments in order to transmit light through the sphere. If the electronic graphics or similar technology is used with the strobes, then the grid behind the spheres or other similar 3D objects would have to be fabricated from translucent material.

When the right strobe 1110 is flashed, the lens directs the image toward the left eye 305. When the left strobe 1105 is flashed, the lens directs the image toward the right eye 310. Synchronized with the alternate strobing are alternate images created on the electronic graphics array: one for the left eye when the right strobe is flashed, and one for the right eye when the left strobe is flashed.

By changing the synchronized images and strobe flashes at a high enough frequency, two different images can be created: one seen principally by the left eye, and the other seen principally by the right eye. When the viewer's brain integrates these two images, the 3D effect is created without use of special glasses or any other aid required by the viewer.

The technology of the present invention can be adapted to numerous applications such as computer screens, television, electronic game displays, display panels on office equipment and home appliances, or any other back-lighted viewing screen. The images can be static or dynamic. Gray scales can be created by dithering groups of pixels into larger pixels that contain various combinations of black and white sub-pixel elements. Note that the system can be adjusted for viewing at various distances from the screen by adjusting the location of the strobes. Note also that the same technology can be adapted such that the viewer can select either 2D or 3D images. For 2D images, the same data is presented for the flashes to right and left eyes; it is not required that both strobes flash at the same time (although that is certainly a possibility), and power management may make it desirable that the strobes always alternate.

Moreover, 3D color images can be created by providing colored tints to the translucent elements of the spheres and clustering the spheres in groups of three, each with the equivalent colors for translucent light as currently used in cathode ray tubes for computer screens and television sets.

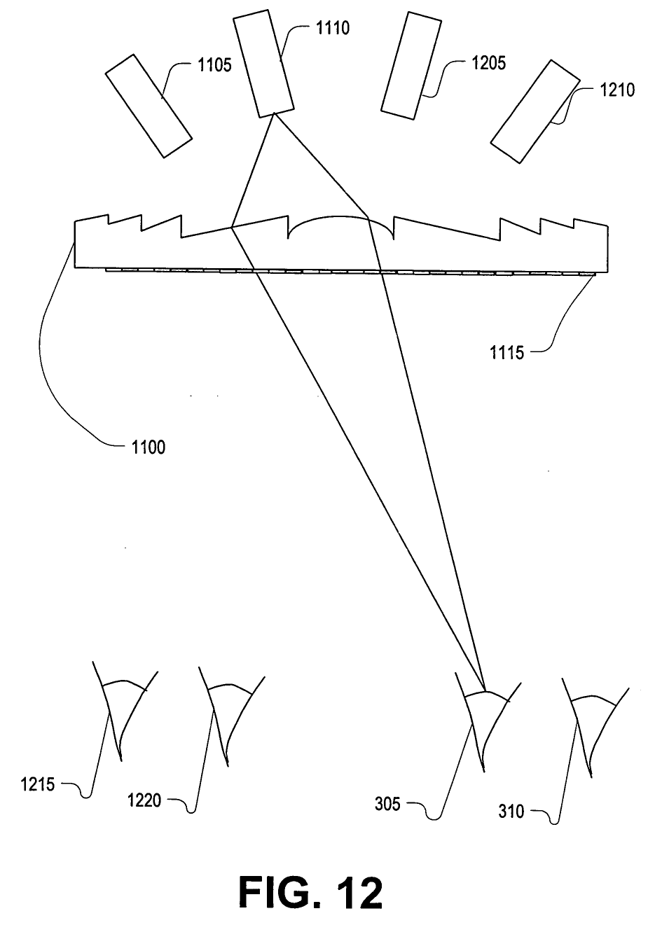

The strobe approach can be used with either the usual unmodified electronic graphics technology of the prior art or with the modified electronic graphics technology, or alternate technology. It is also interesting to consider that more than one pair of strobes can be used so that a first pair of strobes 1110 and 1105 will be directed toward a first pair of eyes 305 and 310, respectively, and a second pair of strobes 1210 and 1205 will be directed toward a second pair of eyes 1215 and 1220, respectively, as illustrated in FIG. 12. For example, the LCD panel 1115 can be used to create a television image, and two people could sit in assigned spots where respective pairs of strobes would be directed, even though only one display screen would be necessary. In this way, the electronic graphics is capable of providing a 3D image to multiple viewers instead of to just one viewer.

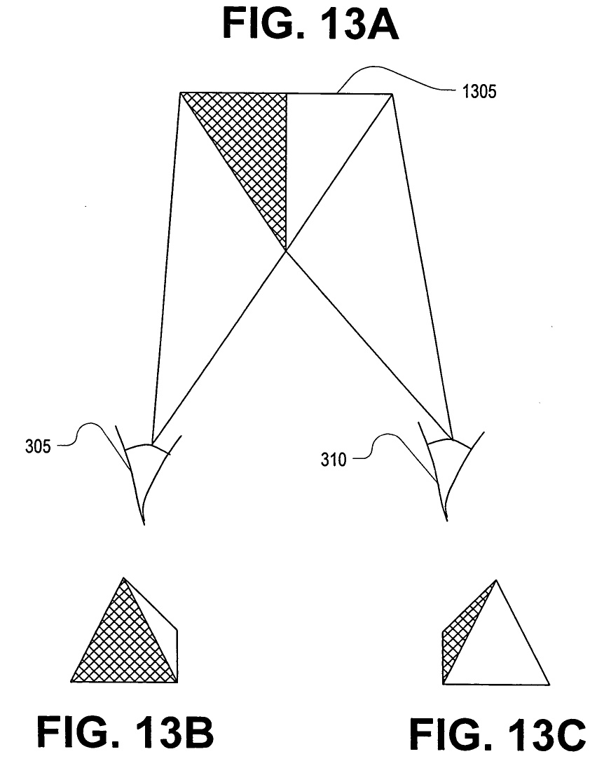

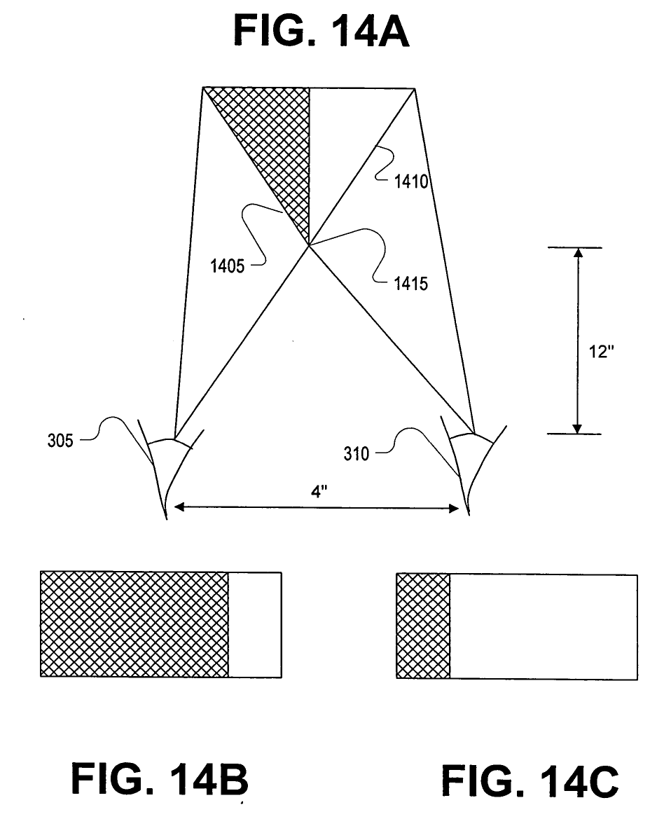

Referring now to FIG. 13A, this shows left and right eyes viewing a tetrahedron 1305 in the same manner as the sphere was viewed in FIG. 3A. Likewise, FIGS. 13B and 13C show the corresponding views of the “pixel” by the two respective eyes just as was done for the sphere in FIGS. 3B and 3C. Similarly, FIG. 14A shows a viewer observing two imaged panels representing pixels mounted at an angle to one another that comprises a black panel 1405 and a white panel 1410 joined at an angle with the juncture 1415 facing the nose of the viewer and the black panel towards the left eye 305 and the white panel towards the right eye 310. Of course, a variety of shapes could be used for the panels, including tapering triangles, squares, or rectangles.

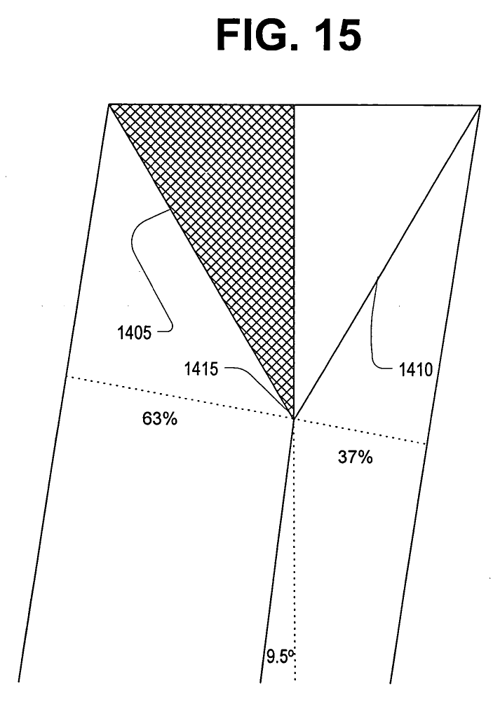

FIG. 15 is a geometric demonstration of the effectiveness of the approach shown in FIGS. 14A-C. At 12 inches, the eyes are converging at a 9.5 degree angle. The path of the right eye view is shown in FIG. 15. The left eye sees about 63% black and 37% white. This means that the difference is 26%, an improvement over the 14% difference that would have been obtained using spheres instead of tetrahedrons, or instead of panels mounted at angles.

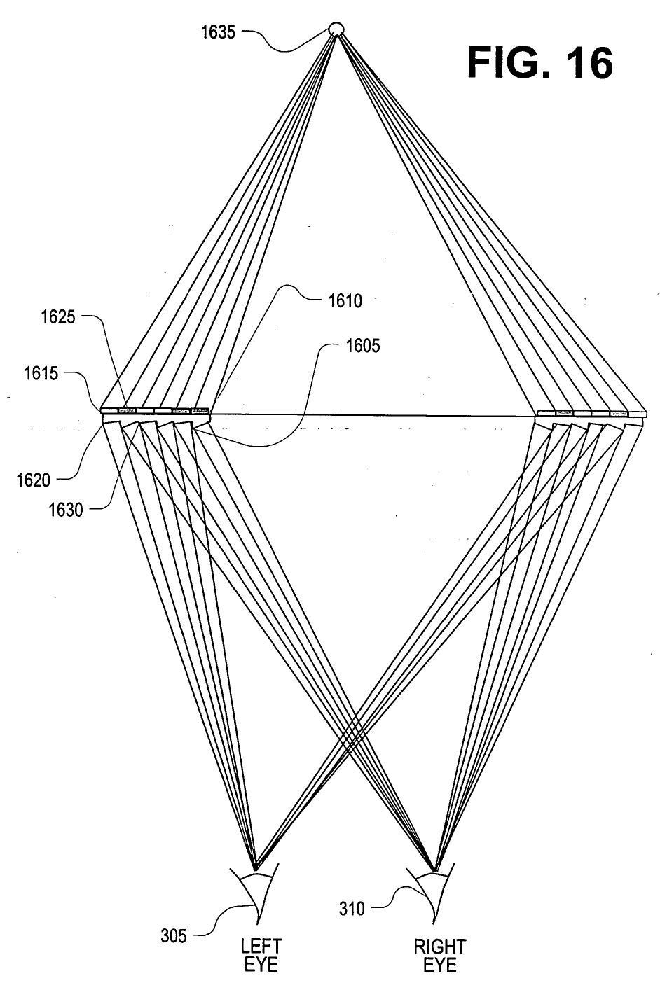

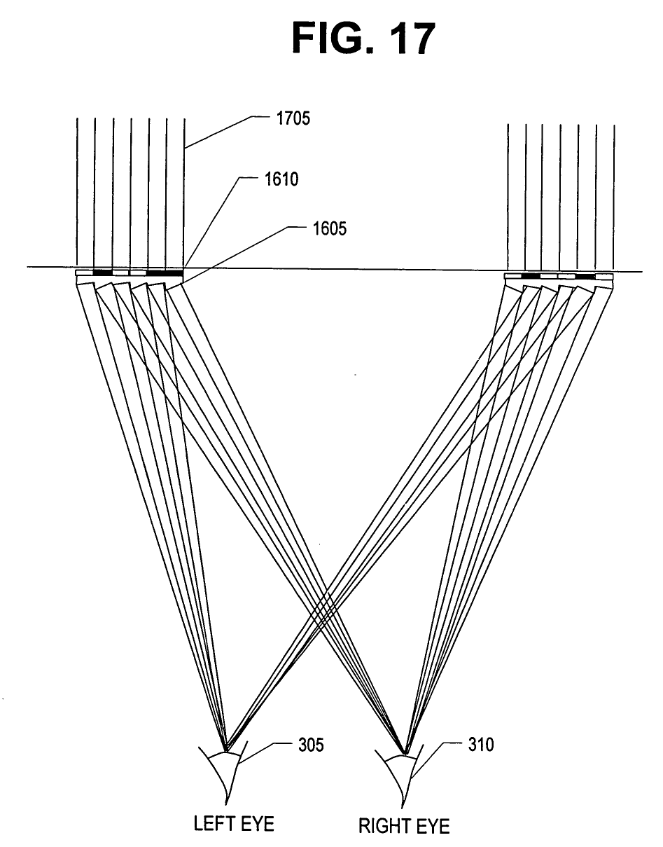

Turning now to FIG. 16, this shows a faceted deflector design that again achieves a 3D effect by departing from a normal flat screen geometry. A faceted deflector 1605 is located between the LCD display 1610 and the viewer's eyes 305 and 310. For a first pixel location 1615 on the LCD display, a first facet 1620 in an overlying relationship with the first pixel has a facet angle selected to deflect the light transmitted through the pixel in a direction associated with the location of the left eye 305. For a second pixel location 1625 on the LCD display adjacent to the first pixel location, a second facet 1630 in an overlying relationship with the second pixel has a facet angle selected to deflect the light transmitted through the pixel in a direction associated with the location of the right eye 310.

In the LCD display, a first plurality of pixels and the associated facets in overlying relationships with the first plurality of pixels will form a composite image and cooperate to deflect the light transmitted through all of the first plurality of pixels toward the location of a first eye of the viewer. A second plurality of pixels and the associated facets in overlying relationships with the second plurality of pixels will form a composite image and cooperate to deflect the light transmitted through all of the second plurality of pixels toward the location of a second eye of the viewer. The light transmitted through the pixels may come from a point source 1625 as shown above in FIG. 16 or from a distant source so that the rays 1705 are essentially parallel as shown in FIG. 17. The images might be static or dynamic (changed at regular intervals), black and white, or in color, depending only on the operation of the LCD panel 1610.

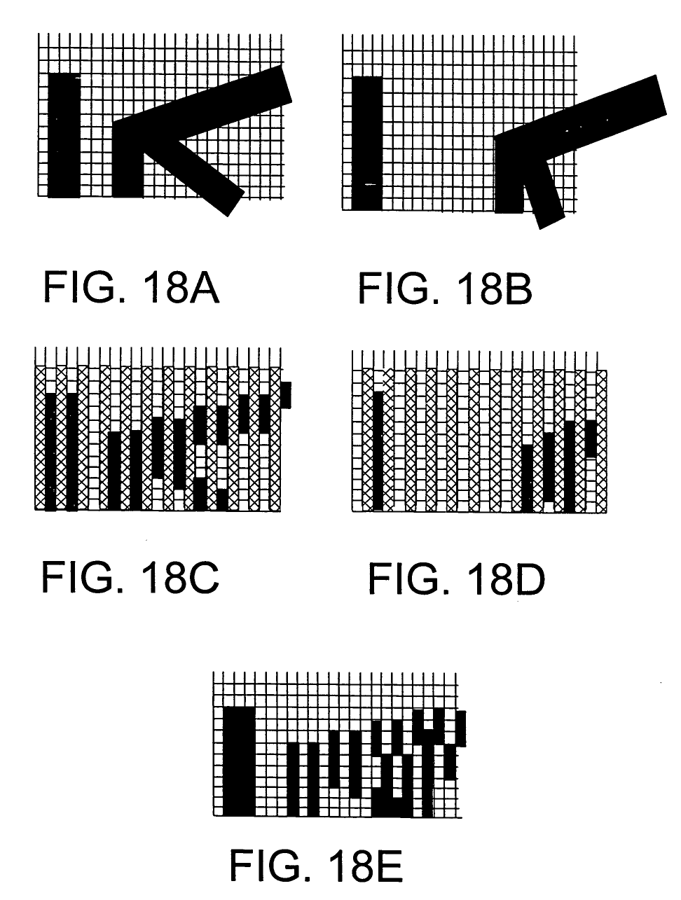

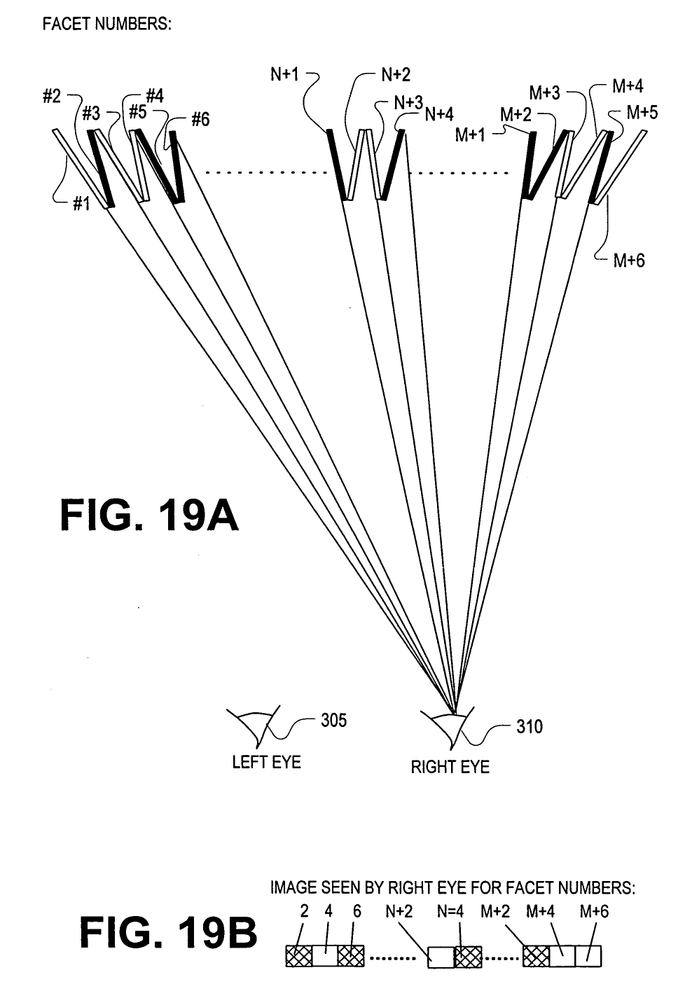

Regarding FIG. 18A, this shows the upper left hand corner of the box and reference line from FIG. 10A as viewed by the left eye. Likewise, FIG. 18B shows the upper left hand corner of the box and reference line from FIG. 10B as viewed by the right eye. In FIG. 18C, we see the LCD image on pixels having facets that deflect image toward left eye using the deflector 1605 discussed above. Images directed toward the right eye are not seen by left eye, and thus are shown crosshatched in FIG. 18C. Similarly, FIG. 19D shows an LCD image on pixels having facets that deflect image toward the right eye. Again, images directed toward the left eye are not seen by the right eye, and therefore are shown crosshatched in FIG. 18D.

Regarding FIG. 18E, this shows the jumbled image that would be created on the LCD display, as seen with the faceted deflector removed. This image includes two images superimposed: one as seen by the left eye and one as seen by the right eye.

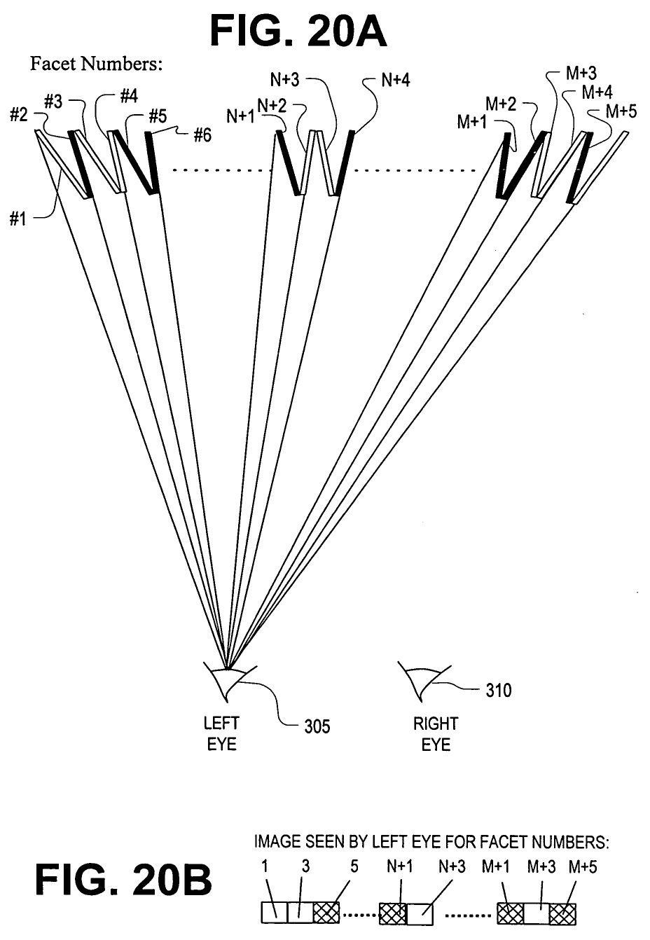

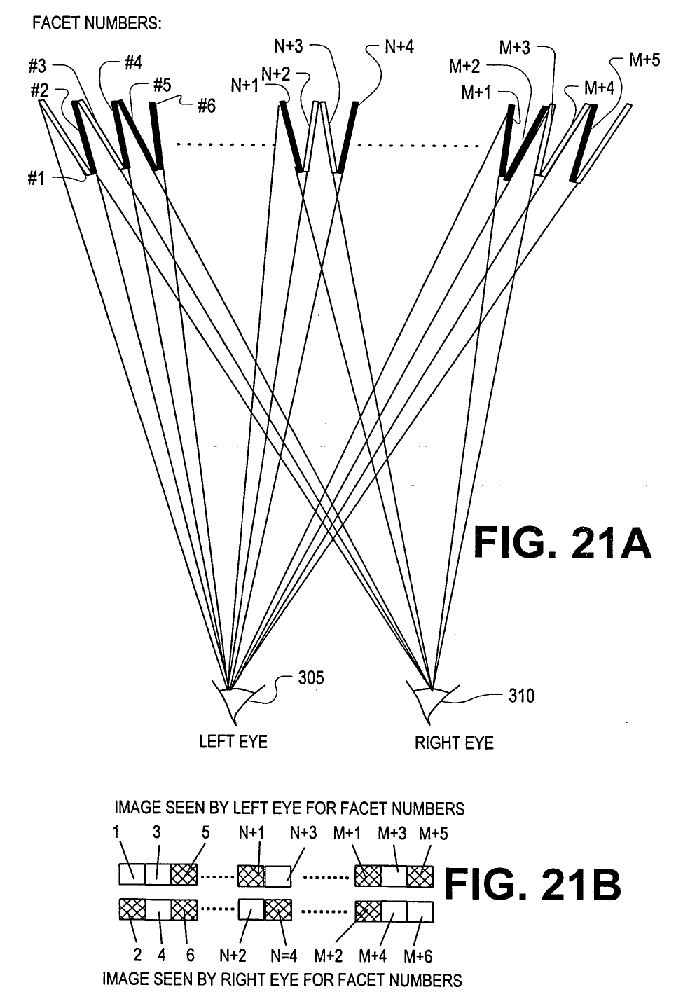

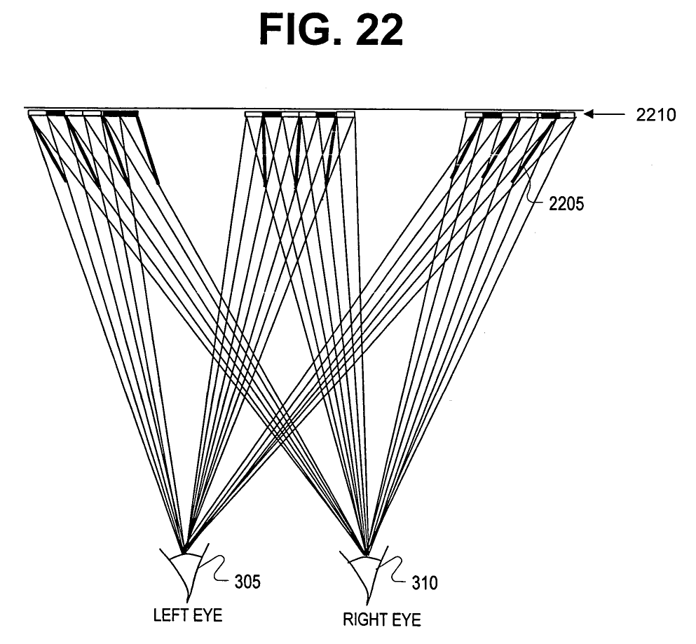

Turning now to FIG. 19A, this shows another arrangement of pixel facets for creating stereo (3D) images without the viewer requiring special optical devices. In this arrangement, adjacent pairs of facets are arranged at an equal angle about a reference line that passes thru the point at which the adjacent facets abut one another, and extending to a point halfway between the viewer's eyes. This is similar to FIG. 14A except that for each pair of facets, only one of the two panels is visible to each eye regardless of where the pair of pixels is located on the image display. This arrangement allows 3D imaging of line art, since for each pair of pixels one is visible only to the left eye and one to the right eye, and one can be black while one can be white. FIGS. 19A-B detail the effects on the right eye 310; FIGS. 20A-B detail the effects on the left eye 305; and FIGS. 21A-B show the combined effect on both eyes.

Regarding FIG. 22, this shows an additional embodiment that again departs from a standard flat screen. This embodiment of FIG. 22 requires a series of optical barriers 2205, and two images comprised of pixels in a grid pattern superimposed on one another in a single imaging plane 2210. The barriers extend outward from the plane of the pixels in a direction toward a point midway between the viewer's two eyes 305 and 310.

The optical barriers may be placed at the left edges of odd numbered pixels across the image, or could be placed at the right edges, or this could be done for even pixels instead of odd pixels. The optical barriers may extend in a vertical direction parallel with the vertical rows of pixels. The length of the barriers in the outward direction is sufficient to block visibility of half the pixels for each eye. The image to be viewed by the right eye would be comprised of the pixels in the odd numbered vertical rows only, and the image to be viewed by the left eye would be comprised of pixels in the even number of vertical rows only.

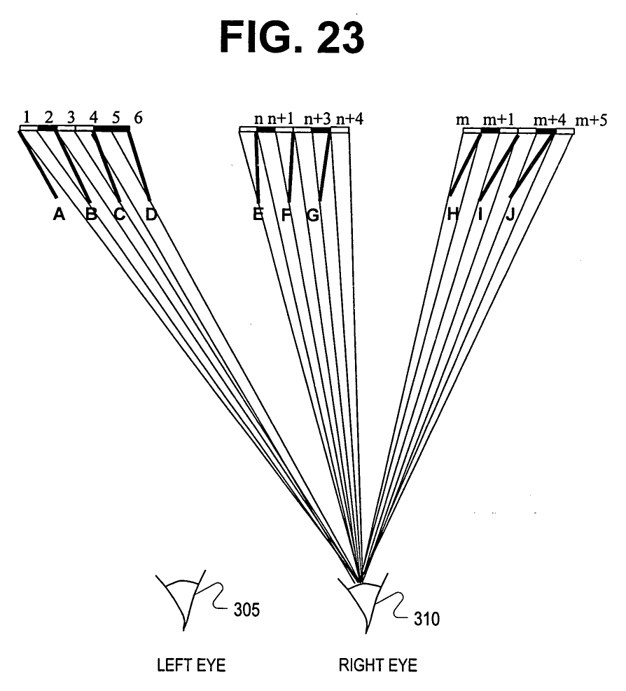

To clarify the barrier concept, in FIG. 23, all of the light rays to the left eye have been removed and only those to the right eye are shown. The location, direction, and length of barrier B are such that the right eye can see the image in vertical rows of pixels 1 but cannot see vertical rows of pixels 2. Similarly, barrier C enables the right eye to see the pixels in vertical row 3 but not in row 4. Barrier F enables the right eye to see the pixels in vertical row n but not row n+1. Barrier H enables the right eye to see the pixels in vertical row m+1 but not row m, et cetera.

In general, the series of barriers A, B, C . . . J enables the right eye to see every other vertical row of pixels, for example, the odd rows; and at the same time blocks the right eye from seeing the complementary set of vertical rows of pixels, for example, the even rows.

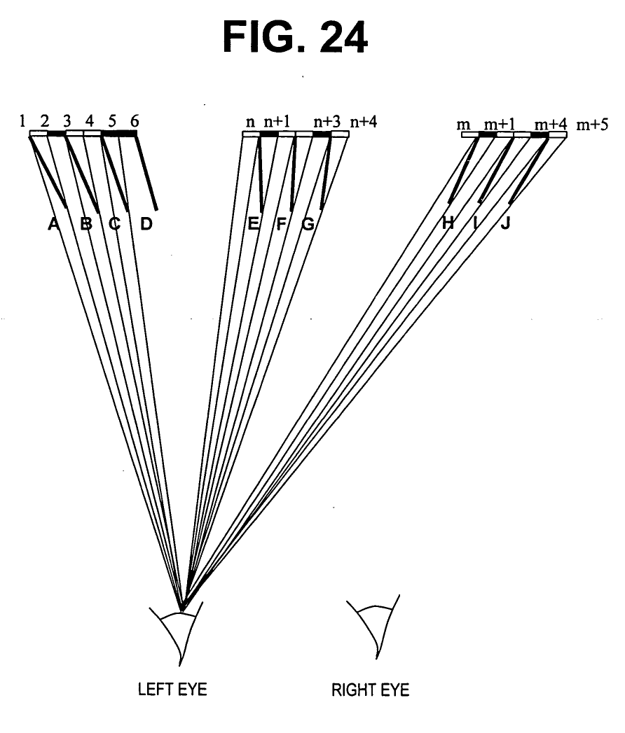

Regarding FIG. 24, this reproduces FIG. 22 with the rays toward the right eye deleted so that only the rays to the left eye can be seen. At the same time as barriers A, B, C . . . J enable the right eye to see pixels in, for example, only the odd rows and blocks the right eye from seeing the rows of pixels in the even rows, the same barriers do just the opposite for the left eye. The same barriers enable the left eye to see the rows of pixels in the even vertical rows but block the left eye from seeing the pixels in the odd vertical rows. So, as seen in FIG. 24, barrier B, which blocked the right eye from seeing pixel 2 while it enabled the right eye to see pixel 3, simultaneously enables the left eye to see pixel 2 while blocking it from seeing pixel 3.

So, the image intended to be viewed by the right eye is created using only the half of pixels which can be seen by the right eye—in this example, the odd vertical rows. The image intended to be viewed by the left eye is created using only the half of the pixels that can be seen by the left eye—in this example, the even vertical rows. Whether the images are static or dynamic, the images intended for the left and right eyes are created separately in alternate in vertical rows that are intermeshed with one another.

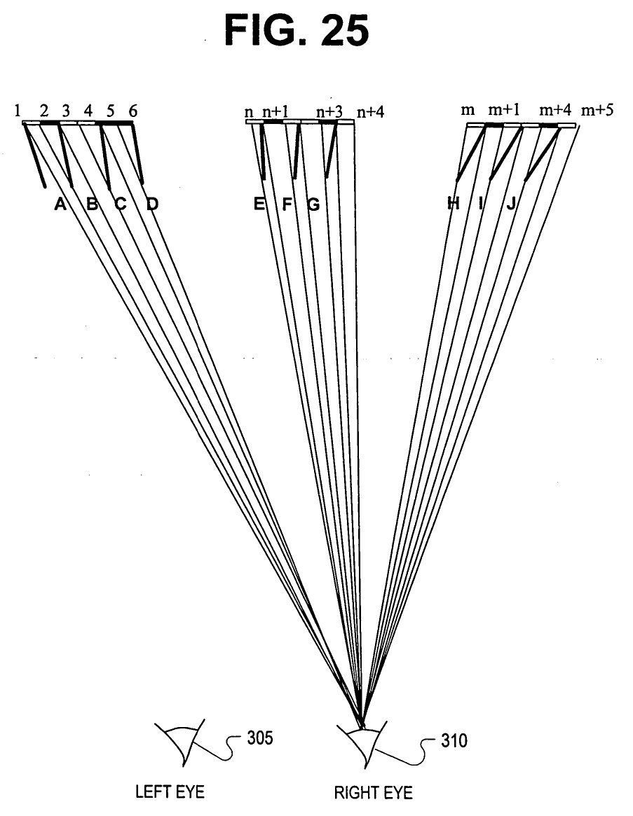

Regarding FIG. 25, this represents a brief study to see what happens if the distance from the image to the viewing point is increased by about 70%, again using the barrier apparatus. It is interesting that on the left side of the image, all of the even rows of pixels and some of the odd rows become visible by the right eye. On the left side of the picture, less of the even rows and none of the odd rows become visible. The opposite will happen for the left eye. Thus, the viewer's eyes may move closer to or further away from the image relatively short distances without affecting the image quality. But if the viewer moves elsewhere in the room—closer or further away—the 3D effect will be significantly impacted. It will also be noted that this system is highly limited by the location of the viewer from left to right. So, if the right eye moves only 3″ to the left, it will see exactly what the left eye would have seen in the original position. Keeping the viewer in the correct position is important.

It is to be understood that all of the present figures and the accompanying narrative discussions of best mode embodiments do not purport to be completely rigorous treatments of the method, terminal, and system under consideration. A person skilled in the art will understand that the steps of the present application represent general cause-and-effect relationships that do not exclude intermediate interactions of various types, and will further understand that the various structures described in this application can be implemented by a variety of different combinations of hardware and software and in various configurations which need not be further elaborated herein.

What is claimed is:

1. A display apparatus for creating a modifiable three-dimensional image, comprising:
(A) a plurality of non-planar pixel units arranged substantially on a plane, wherein each of the non-planar pixel units has a visual impact that is a function of direction; and
(B) an electronic device for modifying said functions to change said three-dimensional image.

2. The display of claim 1, wherein each of the plurality of non-planar pixel units comprises a planar liquid crystal display element separated from a viewer by a non-planar facet of a faceted deflector.

3. The display of claim 1, wherein each of the plurality of non-planar pixel units comprises at least one optical barrier for preventing at least one eye from seeing at least part of the pixel units.

4. The display of claim 1, further comprising at least two strobe lights for backlighting each of the plurality of non-planar pixel units with strobed light pointing in a least two respective directions.

5. The display of claim 4 in which each of said plurality of non-planar pixel units comprises an addressable image segment and a non-planar facet of a faceted deflector, half of said facets dimensioned to deflect the light from the first of said at least two strobe lights to a first common focal point, and the other half of said facets dimensioned to deflect the light from the second of said at least two strobe lights to a second common focal point.

6. The display of claim 1, wherein the plurality of non-planar pixel units is comprised of pairs of non-planar pixel panels, each panel of each of said pairs mounted to abut the other panel of each of said pairs at one common edge, and each panel of said pair of pixel panels mounted at an equal but opposite angle with respect to the other panel of said pair with respect to a line extending from the point at which said pair abuts each other to a point halfway between the viewers two eyes.

7. A display apparatus for creating a three-dimensional image, comprising:
(A) a plurality of transparent or translucent capsules arranged substantially on a plane;
(B) a first plurality of pigmented charged chips in each of the capsules;
(C) a second plurality of oppositely charged chips in each of the capsules, each of the oppositely charged chips having an appearance different from the first plurality of pigmented charged chips in the respective capsule;
(D) an addressable grid of electrodes for positioning the first plurality of pigmented charged chips and the second plurality of oppositely charged chips within each of the capsules;
(E) wherein a visible ratio of the charged chips to the oppositely charged chips in each of the capsules is a function of a position from which the display apparatus is viewed,
(F) wherein the function is controlled by the positioning performed by the addressable grid of electrodes, and
(G) wherein the capsules collectively form the three-dimensional image viewed from at least two vantage points.

8. The display apparatus of claim 7,
(A) wherein the at least two vantage points are a person's left eye and right eye, and
(B) wherein the three-dimensional image is visible to the person without wearing any device.

9. The display apparatus of claim 7, wherein the capsules are spherical, the pigmented charged chips are black, and the oppositely charged chips are white.

10. The display apparatus of claim 7, wherein the grid of electrodes is essentially transparent or translucent.

11. The display apparatus of claim 7,
(A) wherein the oppositely charged chips in each of the capsules have a uniform color tint,
(B) wherein the oppositely charged chips have at least three different color tints, and
(C) wherein the capsules having the at least three different color tints are clustered together in groups so that each of the groups contains all of the at least three different color tints.

12. The display apparatus of claim 11, wherein the three-dimensional image is a dynamic color image.

13. The display apparatus of claim 11 wherein the three-dimensional image is a static color image.

14. The display apparatus of claim 7 wherein the three-dimensional image is a static black and white image.

15. The display apparatus of claim 7 wherein the three-dimensional image is a dynamic black and white image.

16. The display apparatus of claim 11,
(A) wherein the addressable grid of electrodes includes a double grid mesh, and
(B) wherein each of the capsules is affected by two different charges from the electrode.

17. The display apparatus of claim 7, wherein the capsules are oblong.

18. The display apparatus of claim 7, wherein both the capsules and the chips are substantially spherical.

19. A display apparatus for creating a three-dimensional image, comprising:
(A) a plurality of transparent or translucent capsules arranged substantially on a plane;
(B) a first plurality of charged chips in each of the capsules;
(C) a second plurality of oppositely charged chips in each of the capsules, each of the oppositely charged chips having an appearance different from the first plurality of charged chips in the respective capsule;
(D) at least one addressable grid of electrodes for positioning the first plurality of charged chips and the second plurality of oppositely charged chips within each of the capsules;
(E) wherein a visible ratio of the charged chips to the oppositely charged chips in each of the capsules has a value that is substantially equal to either zero, one, or infinity, as viewed from any point along a line that intersects the one of the capsules and is perpendicular to the plane, and
(F) wherein the capsules collectively form the three-dimensional image viewed from at least two vantage points.

20. The display apparatus of claim 19, wherein the first plurality of charged chips are opaque, and the second plurality of charged chips are not opaque.

21. A method for creating a three-dimensional image on a display, comprising:
(A) arranging a plurality of transparent or translucent capsules substantially on a plane, including a first plurality of pigmented charged chips in each of the capsules, and a second plurality of oppositely charged chips in each of the capsules, each of the oppositely charged chips having an appearance different from the first plurality of pigmented charged chips in the respective capsule; and
(B) instructing at least one electrode to position the first plurality of pigmented charged chips and the second plurality of oppositely charged chips within each of the capsules;
(C) wherein a visible ratio of the charged chips to the oppositely charged chips in each of the capsules is a function of a position from which the display apparatus is viewed,
(D) wherein the function is controlled by the positioning performed by the at least one electrode, and
(E) wherein the capsules collectively form the three-dimensional image viewed from at least two vantage points.

22. The method of claim 21, further comprising the steps of
(A) changing the visible ratios by changing the charges on said at least one electrode over time,
(B) backlighting the display with at least two strobes that are directed in different directions, and
(C) flashing the strobes at different respective times synchronized with changing the visible ratios by said at least one electrode.

23. The method of claim 21,
(A) wherein the at least two vantage points are a person's left eye and right eye, and
(B) wherein the three-dimensional image is visible to the person without wearing any device.

24. A display apparatus for creating a three-dimensional image, comprising:
(A) a grid with plural translucent segments arranged substantially on a plane;
(B) a means to selectively change any of the plural translucent segments to opaque segments to form a first image and a second image,
(C) means to backlight the display with at least two strobes that are directed in different directions,
(D) wherein the first of the at least two strobes flashes at a time associated with the first image, and the second of the at least two strobes flashes at a time associated with the second image, and
(E) wherein the first image and the second image are viewed from different vantage points.

25. The display apparatus of claim 24, wherein the at least two strobes comprise a plurality of pairs of strobes, each of the pairs being directed toward positions for a viewer's eyes.

26. The display apparatus of claim 25, wherein the plurality of pairs of strobes remain at fixed orientations unless readjusted to accommodate new viewer positions.

27. The display apparatus of claim 24, wherein the strobes are separated from a viewer by a plurality of non-planar facets of a faceted deflector.

28. The display apparatus of claim 27, wherein the non-planar facets are respectively part of the segments.

29. A method of creating a three-dimensional image in a display having a plurality of picture elements which can be selectively made translucent and opaque, comprising:
(A) creating a first image by selecting a predetermined pattern of plural translucent and opaque picture elements,
(B) flashing a first strobe,
(C) passing the light from the first strobe through the display in a first direction,
changing at least one part of the predetermined pattern of plural translucent and opaque picture elements,
(D) flashing a second strobe, and
(E) passing the light from the second strobe through the display in a second direction.

30. The method of claim 29, wherein the picture elements have faceted deflectors in an abutting relationship.

31. An apparatus for creating a three-dimensional image in a display having a plurality of picture elements that can be made selectively a first color and a second color comprising:
(A) optical means for directing light reflected from at least one of the picture elements in a first direction and
(B) optical means for directing light reflected from at least a second one of the picture elements in a second direction.

32. An apparatus for creating a three-dimensional image in a display having a plurality of picture elements which can be selectively made a first color and a second color, comprising:
(A) optical means for directing light reflected from a first plurality of the picture elements in a plurality of directions that converge at a first single point, and
(B) optical means for directing light reflected from a second plurality of picture elements in a plurality of directions that converge at a second single point.

33. An apparatus for creating a three-dimensional image in a display having a plurality of picture elements which can be selectively made a first color and a second color, comprising:
(A) optical means for directing light transmitted through a first plurality of the picture elements in a plurality of directions that converge at a first single point, and
(B) optical means for directing light transmitted through a second plurality of picture elements in a plurality of directions that converge at a second single point.

34. A method of creating a three-dimensional image in a display, comprising:
(A) arranging a plurality of non-planar pixel units substantially on a plane, wherein each of the non-planar pixel units has a visual impact that is a function of direction, and
(B) modifying said functions in order to change said three-dimensional image.

35. The method of claim 34, wherein a substantially three-dimensional image is created insofar as the image is within a range of gray values, but a substantially two-dimensional image is created insofar as the image is outside the range of gray values.
